(19) United States
(12) Patent Application Publication
(10) Pub. No.: US 2007/0221561 A1
(43) Pub. Date: Sep. 27, 2007

(54) LIQUID FILTRATION SYSTEMS

(75) Inventors: Charles C. Funkhouser, Old Saybrook, CT (US); John L. Pulek, Cheshire, CT (US); Laurence W. Bassett, Killingworth, CT (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/690,061

(22) Filed: Mar. 22, 2007

Related U.S. Application Data
(60) Provisional application No. 60/785,396, filed on Mar. 22, 2006.

(51) Int. Cl. B01D 27/00

(52) U.S. Cl. 210/232; 210/504; 210/510.1

(57) ABSTRACT

Provided are liquid filtration systems and filter elements. An aspect of the invention provides a filter element comprising: a filter block having an inlet and an outlet; an end cap having a handle and a passage, the passage operatively connecting the outlet of the filter block with an end location; and a housing comprising a shroud and an opening, the housing being adjacent to the end cap, wherein the inlet of the filter block is directly operatively connected to the opening of the housing. Another aspect of the invention provides a filtration system comprising the filter element and a pressure vessel. The pressure vessel comprises an inlet port that is adjacent to the shroud such that upon fluid flowing through the inlet port, the fluid contacts the shroud and the direction of flow changes, and wherein the inlet port is in fluid communication with the inlet of the filter block.

### CROSS-REFERENCE TO RELATED APPLICATIONS

This application claims the benefit of priority under 35 U.S.C. § 119(e) to U.S. Provisional Application No. 60/785,396, filed Mar. 22, 2006, the disclosure of which is hereby incorporated by reference in its entirety.

### TECHNICAL FIELD

The present disclosure relates to water filtration systems and filter elements, wherein the filter elements contain filter media therein.

### BACKGROUND

Numerous types of home water filtration systems are commercially available. Some of these systems utilize distillation, activated carbon filtration, sediment filters, deionization, ion exchange, reverse osmosis separation, and other types of filtration and separation systems for removing impurities from potable water. The types of systems available to the homeowner range from simple filters with limited capacities that remove impurities to elaborate and expensive systems, which may be complex and cumbersome.

Filtration systems can be located “inline” or at the “point-of-use” (POU). Many home owners prefer to install the point-of-use systems since they do not want to cut into their plumbing to install an inline filtration system or pay a plumber to do so. Common point-of-use filtration systems include pitcher filters, end-of-faucet filters and countertop filters, and users typically select one of these systems based on personal preference as will be explained here.

End-of-faucet filtration systems are mounted directly to the end of the faucet. There are some users that do not like the aesthetics of a filter hanging off of the faucet and others feel the filter gets in the way while using the faucet and sink.

Countertop filtration systems typically have tubing that permanently connects to the end of the faucet. There are some users that don't like the aesthetics of the tubing attached to the faucet, others that feel that the tubing gets in the way when they use the faucet or sink, and others that don't like the loss of countertop space.

There are presently primarily two types of known pitcher filtration systems. The most commonly known pitcher filtration system is the gravity feed style such as those manufactured and sold by Brita and PUR. There are some users that do not particularly like these gravity feed type pitchers, as by nature these gravity feed filter systems take much longer to fill the pitcher container than it takes to fill the same volume container from a faucet that includes an inline filter system or an installed end of faucet filter system. However, other end users like the ability to store the pitcher in the refrigerator so that the water temperature is relatively cold when the water is poured for consumption.

There are also pitcher filtration systems that connect to the end-of-faucet so that pressurized water is supplied to the filter, which in turn filters the water as the container is being filled. The benefit of the pressurized water source is that it provides for the container being filled much faster than with the gravity feed filters. These particular type pitcher filtration systems are then disconnected from the faucet and can be stored in the refrigerator as well in order to keep the filtered water relatively cold. Some users do not like having to connect and disconnect the pitcher to the faucet each time they want to fill the container. Examples of these types of pressurized pitcher filtration systems include U.S. Pat. Nos. 4,776,956 to Gannaway and 5,454,944 to Clack, and PCT Application Publication WO 00/37363 to Kimberly-Clark.

Most water filtration systems require a pressure vessel connected to an influent supply of potable water. The water enters the pressure vessel and the impurities in the water are filtered and/or separated out by the water being forced under pressure through a filtering or separating medium. The effluent purified water is directed to an outlet for consumer use. Typically, the pressure vessel is contained in an outer housing, which is more aesthetically pleasing in appearance than the pressure vessel. In addition, the usual apparatus has the inlet at one end of the pressure vessel and the outlet at the other end of such vessel. Thus, it is not unusual that significant plumbing considerations are encountered to accommodate the pipes, tubes, or hoses needed to connect the filtration system to the homeowner's present plumbing.

There are systems that provide an end cap that is attached to the filter media and is part of the pressure boundary yet has no fluid port because its function is only to close the pressure vessel and not to act as a fluid flow outlet. Fluid communication is through the opposite end of the pressure vessel, as in U.S. Pat. No. 6,325,929 to Bassett.

It is known that fluid flow impinging directly on the filter media may cause erosion and damage to the filter media, which could adversely affect the filter media filtration and/or separation performance, i.e., contaminant removal. Others have solved this problem by relocating the inlet to various locations so that the fluid entering the inlet connection would not impinge directly on the filter media, or would impinge on a plastic component such as an end cap. For example, the inlet can be located closer to one end of the pressure vessel sump where there is no filter media adjacent to the inlet opening. However, this proposed solution has the effect of increasing the sump length, which is not tolerable when trying to make smaller compact filtration systems. This proposed solution could also cause an increase in the amount of tubing that attaches to the inlet connection, which adds cost and complexity. The inlet can also be incorporated into the cover but this also increases the system size and could create additional steps when installing or removing the filter.

In some prior art POU filtration systems, the user must perform multiple steps to install or remove the filter, i.e., detach tubing from the inlet and outlet connection before removing the filter element from the system. It is also recognized, however, that there are some POU filtration systems that also require only a single step to install and remove the filter, as disclosed in commonly owned U.S. patent application Ser. No. 11/239,607, filed Sep. 29, 2005, now U.S. Patent Application Publication 2006/0065607 published on Mar. 30, 2006, the disclosure of which is incorporated by reference to the extent not inconsistent with the present application.

As is known, the filter element has the potential to leak and/or disengage from the pressure vessel if not properly secured in the pressure vessel when under pressure (i.e., typical water line pressure of about 30 to about 100 psig) which can cause damage to property.

There is an on-going need to provide safer and more compact water filtration systems for home use. There is also a need to provide systems that minimize the number of steps and components needed to operate and maintain the systems. It would be further desirable to minimize erosion and damage to filter media. In addition, there is need to provide such benefits without adding cost and complexity to the filtration systems not valued by the end-user.

### SUMMARY

Liquid filtration systems and filter elements are provided. In a first aspect, a filter element comprises: a carbon block comprising a first surface and a second surface; an end cap to which the carbon block is secured, the end cap comprising a handle, wherein the handle defines a passage that is in fluid communication with the second surface of the carbon block and that operatively connects the second surface with an end location; and a shroud surrounding the carbon block, the shroud comprising an opening and being operatively connected to the end cap, wherein at least a portion of the first surface of the carbon block is in fluid communication with the opening of the shroud.

In one or more embodiments, the carbon block comprises activated carbon and a binder. In an embodiment, the binder is polymeric. In a detailed embodiment, the polymer is ultra high molecular weight polyethylene.

In another embodiment, the shroud is integral to the end cap.

In another aspect, a fluid filtration system comprising the filter element and a pressure vessel is provided. The pressure vessel comprises an inlet port that is adjacent to the shroud such that upon fluid flowing through the inlet port, the fluid contacts the shroud and the direction of flow changes, and wherein the inlet port is in fluid communication with the first surface of the carbon block. In one embodiment, the end cap further comprises an engagement ledge and the pressure vessel further comprises an engaging cam shoulder, the engagement ledge and the engaging cam shoulder forming an interlock that connects the filter element to the pressure vessel.

A further aspect provides a fluid filtration system comprising: a reservoir; a pressure vessel affixed within the reservoir; a filter element that is operatively connected to the pressure vessel; and a lid affixed to the reservoir, the lid comprising a door having a normal operating position that is substantially flush with the lid; wherein when the filter element is improperly installed, an interference between the filter element and the door prevents the door from obtaining the normal operating position.

In one embodiment, the filter element comprises a handle and the door comprises a channel configured such that when the door is in the normal operating position, at least a portion of the handle is located within the channel, and when the filter element is improperly installed, an interference between the filter element and the channel prevents the door from obtaining the normal operating position.

The numerous features and advantages of the invention will become more apparent to those skilled in the art upon consideration of the remainder of the disclosure including the detailed description and claims taken in conjunction with the accompanying drawings.

### BRIEF DESCRIPTION OF THE DRAWINGS

In describing embodiments of the invention, reference is made to the various Figures wherein like reference numerals indicate like features and in which:

FIG. 1 is a schematic isometric representation of an embodiment of the liquid filtration system according to the present disclosure;

FIG. 2 is a schematic isometric representation of an embodiment of the filter element according to the present disclosure;

FIG. 3 is a cross-sectional view of the filter element of FIG. 2;

FIG. 4 is a cross-sectional view of an embodiment of the pressure vessel according to the present disclosure;

FIG. 5 is a partial cross-sectional isometric schematic view of the filter element partially inserted into the pressure vessel;

FIG. 6 is a schematic isometric view of the filter element completely inserted into the pressure vessel;

FIG. 7 A is a schematic isometric view of an embodiment of the liquid filtration system according to the present disclosure with the container lid operative positioned thereon and the filter element reservoir lid shown in the open position;

FIG. 7 B is a schematic isometric view of an embodiment of the liquid filtration system according to the present disclosure with the container lid operative positioned thereon and the filter element reservoir lid shown in a proper closed position; and

FIG. 7 C is a schematic isometric view of an embodiment of the liquid filtration systems according to the present disclosure with the container lid operative positioned thereon and the filter element reservoir lid shown in a partially improper open position.

Before describing several exemplary embodiments of the invention, it is to be understood that the invention is not limited to the details of construction or process steps set forth in the following description. The invention is capable of other embodiments and of being practiced or being carried out in various ways.

### DETAILED DESCRIPTION

There are several different and distinct components of the present disclosure, and each component may include a number of different and distinct embodiments, which may be used individually or collectively as will be described below. One or more of the disclosed filter elements are suitable for use in water pitcher filtration systems. And the filter elements could also be used in any point-of-use (POU) open-discharge type filtration device, as would be understood by one skilled in the art.

In accordance with one embodiment of the present disclosure, a baffle is provided as an integral part of the filter element component to prevent the fluid flow as the flow enters the pressure vessel through the inlet from impinging directly onto the filter media. Flow impinging directly on the filter media has been known to cause erosion and damage to the filter media, which could adversely affect the filter media filtration and/or separation performance, i.e., contaminant removal.

A handle of the filter element of the present disclosure serves a dual purpose. First, the handle provides a location for a user to grip the filter element during installation and removal of the filter element from the pressure vessel. The representative disclosed handle also includes an interior hollow chamber that facilitates movement of the filtered fluid from the interior of the filter media to the atmosphere where it is dispensed directly into a container without any additional connections or seals on the downstream side of the filter element. Additionally, in alternative embodiments, the filtered fluid may be directed to other end points other than an interior hollow chamber of the container. For example, the fluid may be directed from the hollow chamber of the filter element handle to fill a glass or sports bottle container that is not part of the filtration system like a pitcher container.

Another feature of the present disclosure is the incorporation into the filter system of a lid that ensures that the filter element is located in its proper position within the filtration system during installation and remains in that position during use. In some embodiments, the interrelationship of the lid with the filter element handle can provide an important safety feature that prevents the filter element from disengaging from the pressure vessel during use, as the filter element is under about 30 to about 100 psig water pressure.

The following define specific terms, as they are understood to be used to the present disclosure.

By the terms “fluid and/or liquid,” we mean any fluid and/or liquid capable of being processed through a filter media, i.e., composite carbon block filters, including, not limited to, potable water, non potable water, industrial liquids and/or fluids or any liquid and/or fluid capable of being process through a filtration apparatus.

By the term “contaminant,” we mean a substance or matter in the fluid that has a detrimental effect on the fluid or subsequent processing or use of the fluid.

By the term “separation,” we mean the method by which contaminants are removed from a fluid by flowing the fluid through a porous structure.

By the term ‘filtration,” we mean the method by which particles are removed from a fluid by flowing the fluid through a porous structure.

By the term “filter media,” we mean the material that actually performs the filtration and/or separation of contaminants from the fluid being treated. There is no limitation on the materials of construction, i.e., the filter media can be made from any materials suitable for use in filtration and/or separation which are currently known to those skilled in the art or become known in the future to those skilled in the art.

By the term “carbon block,” we mean a filter media that contains activated carbon in a generally rigid self-supporting porous structure. It is commonly used in water treatment applications to remove contaminants that impart aesthetic/odor/taste issues, i.e., chlorine, and/or health effects issues, i.e., cysts. Typically the block is cylindrical in shape and has a hollow interior core. The fluid typically flows from the outside of the block through the porous structure to the interior core. The block may be a single open end style (SOE), i.e., interior core visible at one end only, or double open end style (DOE), i.e., interior core is visible at both ends of block. A representative carbon block, and methods of making the same, that would be usable with the filter element of the present application is disclosed in commonly-owned Provisional Patent Application Ser. No. 60/785,397, filed Mar. 22, 2006, entitled, SYSTEMS AND METHODS OF MOLDING COMPOSITE MEDIA BLOCKS TO A FIXED SIZE AND PRODUCTS PRODUCED BY SAME AND INNOVATIVE FILTER MATERIAL FOR UTILIZATION WITH SUCH COMPOSITE BLOCKS, U.S. patent application Ser. No. ______, filed Mar. 21, 2007, entitled “Filter Media,” U.S. patent application Ser. No. ______, filed Mar. 21, 2007, entitled “Methods of Making Molded Composite Blocks,” the disclosures of which are herein incorporated by reference to the extent not inconsistent with the present application.

By the term “end cap,” we mean bonded to one or both ends of the filter media to seal the end face of the filter media. For a SOE & DOE filter media there is one end cap that provides the attachment and sealing means of the filter media to the pressure vessel. For DOE filter media there is a second end cap at the opposing end that prevents flow from entering the interior core (also referred to as bypass). It is typically made from a thermoplastic material in an injection molding process. In this specific disclosure the end cap also serves as a pressure boundary surface in lieu of a cover (also referred to as head) and includes features that allow it to be adapted to the pressure vessel to hold it in place under pressure.

By the term “baffle,” we mean a component traditionally located within a pressure vessel that deflects the fluid entering the vessel through the inlet from directly impinging on the installed filter media.

By the term “shroud,” we mean material that surrounds some portion of the exterior surface of the filter media. The shroud may be produced integral with the end cap or can be a separate component. Typically made from thermoplastic materials in an injection molding, extrusion, rotational molding or blow molding operation. In this specific disclosure, the shroud acts as a baffle to protect the filter media as the flow enters the pressure vessel through the inlet located in the side wall of the pressure vessel.

By the term “handle,” we mean a feature of the end cap that the user grips to install and remove the filter. In this specific disclosure the handle also serves to communicate flow from the filter media to the container.

By the term “filter element,” we refer to the combination of the filter media, end cap, seal, shroud and any other parts, that are sold as, function as, and get installed/removed as a unit.

By the term “line pressure,” we mean pressure in the plumbing above atmospheric pressure. It is typically measured in units of “psig”.

By the term “inlet connection,” we mean a location where the fluid enters the pressure vessel.

By the term “outlet connection,” we mean a location where the fluid exits the pressure vessel.

By the term “pressure vessel,” we mean a structural component that receives the filter element when the filter element is installed and is intended to hold fluid under pressure higher than atmospheric pressure. Traditionally a pressure vessel is comprised of a sump (also referred to as bowl or housing) and a cover (also referred to as head). A pressure vessel contains at least one inlet and at least one outlet connection, which can be located in either the sump or cover. In this specific disclosure, the pressure vessel comprises a molded sump in combination with the end cap that serves as the cover component.

By the term “filter system,” we mean a system that comprises the pressure vessel and filter element.

By the term “point-of-use (POU) open discharge filter system,” we mean a filter system that is located at the point of use where the filtered fluid is discharging to essentially atmospheric pressure. The system is not subject to line pressure during the off mode. Examples include end of faucet filters, countertop filters and pitcher filters.

By the term “inline filter system,” we mean a filter system that is located in a plumbing system that is pressurized (also referred to as line pressure) in the piping or tubing downstream of the filter system.

By the term “container,” we mean a structure that has the ability to hold fluid, i.e., bottle, can, pitcher, or any other means. A container can be integral with the filter system or can be a separate component.

By the term “pitcher,” we mean a container that holds multiple servings of liquid, such as for example, water.

By the term “sports bottle,” we mean a container that is portable for people on the go.

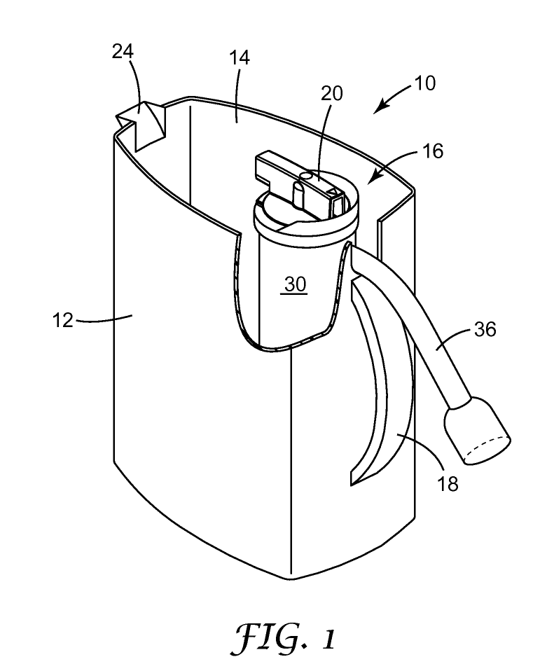

FIG. 1 illustrates one embodiment of a liquid filtration system according to the present disclosure. The embodiment of the liquid filtration system 10 comprises a container or pitcher 12 having at least one opening 14 and defining a filter unit reservoir 16, a pitcher handle 18, and a pressure vessel 30 that receives a filter element 20; the pitcher, pitcher handle, and pressure vessel being conventional.

As would be understood by those skilled in the art, in this particular embodiment, the filter unit reservoir 16 is defined by the interior spaces of the pitcher 12 with the filter reservoir 16 being specifically designed to receive the filter element 20 and the pressure vessel 30 therein. The pitcher 12 comprises a spout 24, for allowing liquid to be moved from the interior of the pitcher to a location exterior thereof. Connecting structure 36, such as, for example, a quick-connect hose, for operatively interconnecting a liquid source to the pressure vessel 30 is operatively connected to the pressure vessel 30 such that fluid flowing from a liquid source (not shown) is directed first into the pressure vessel 30, then through the filter element 20 and finally to the filter unit reservoir 16, a storage compartment, or an end point of use.

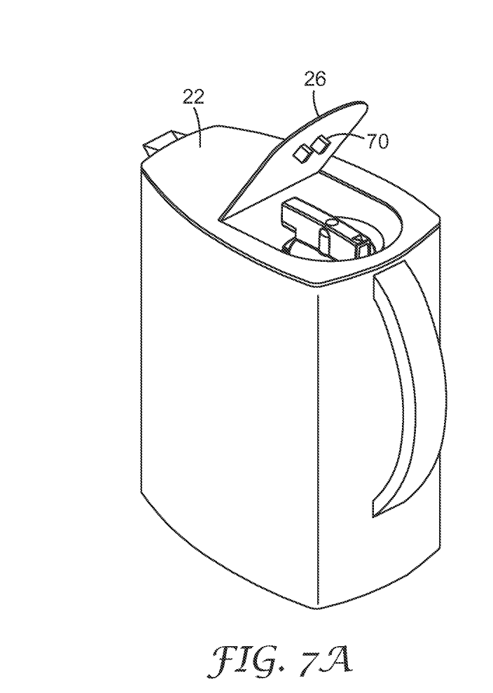

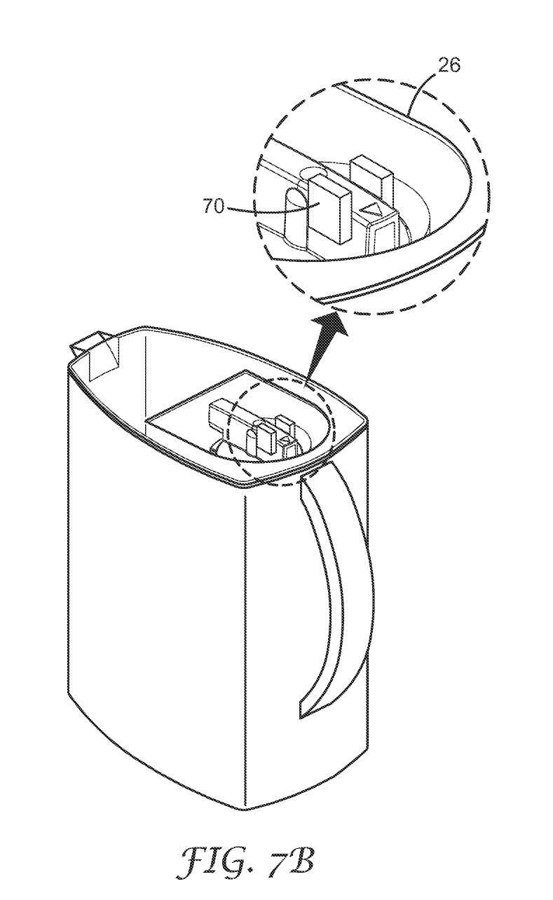

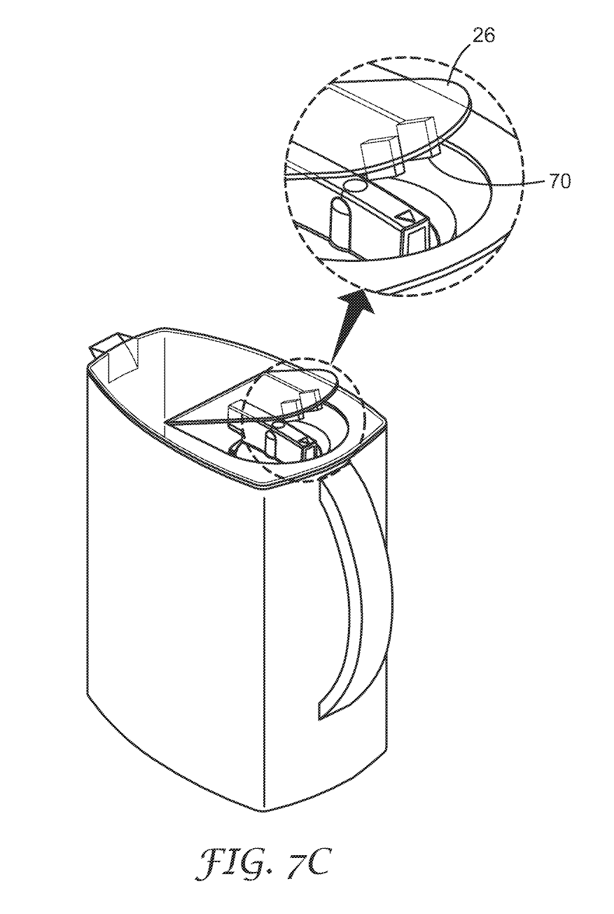

With reference to FIG. 7 A, a pitcher lid 22 is selectively operatively designed to operatively interface with the filter unit reservoir 16 and to operatively seal the open top portion of the pitcher 12. As shown in FIGS. 7A, 7 B, and 7 C, the pitcher lid 22 comprises a door, which can also be referred to as a filter element lid, 26, for providing access to the filter reservoir 16, as will be described herein below.

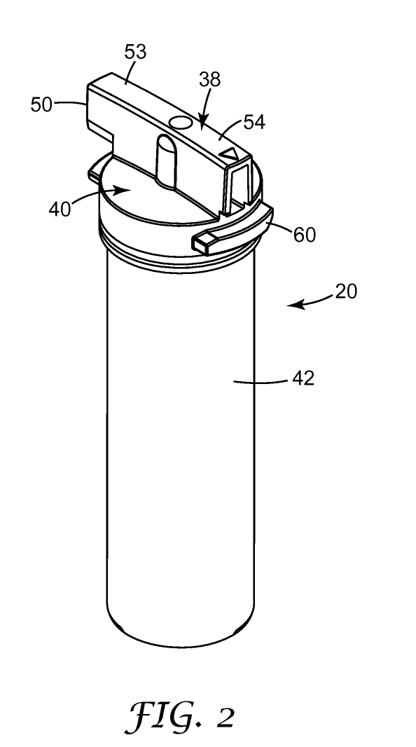

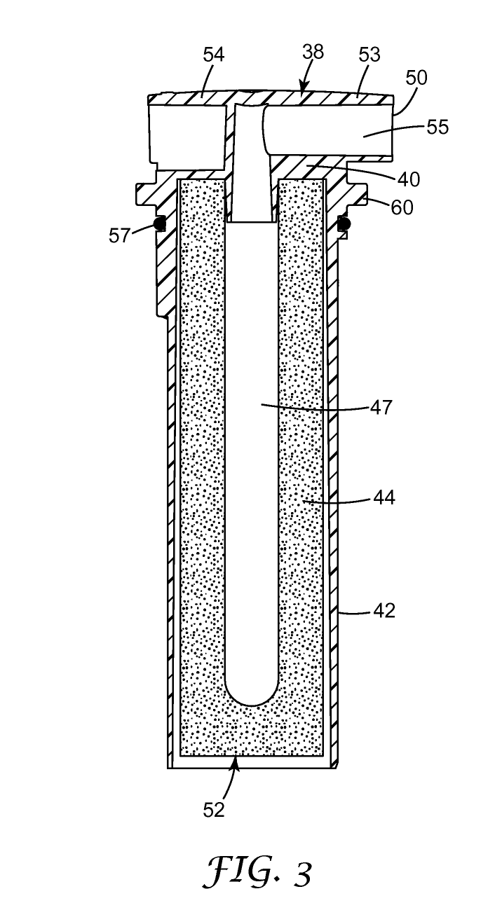

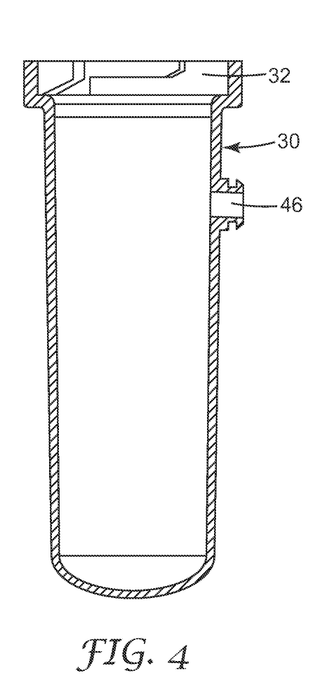

As illustrated in FIGS. 2 and 3, the filter element 20 comprises an end cap 40 having a handle 38 located thereon, a shroud 42 that serves as a baffle, and a carbon block 44 having a hollow interior portion 47 operatively positioned therein. An engagement ledge (also known as a locking ear) 60 is designed to interface and cooperate with engaging cam shoulders 32 of the pressure vessel 30 (FIG. 4) for retaining the filter element 20 securely within the pressure vessel 30. A seal, also referred to as an O-ring, 57 aids in complete sealing between the filter element 20 and the pressure vessel 30 upon assembly. The end cap 40 and the shroud 42 are operatively connected together. In one embodiment, the shroud 42 is formed integral therewith.

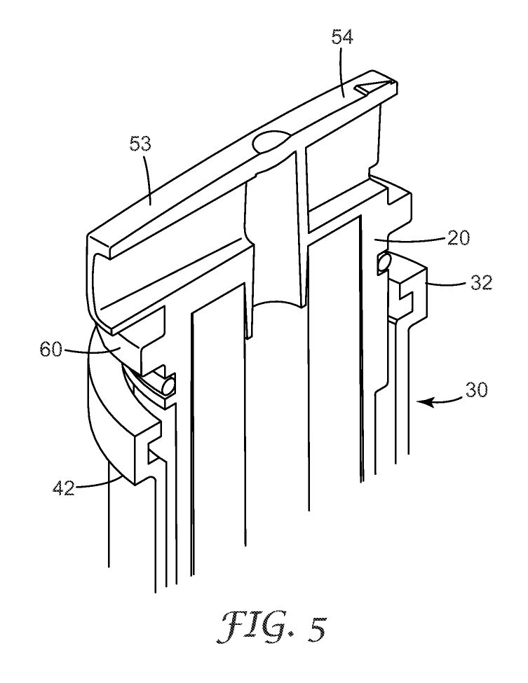

FIGS. 4 and 5 show the pressure vessel 30 designed to operatively receive the filter element 20 therein. The pressure vessel 30 includes the engaging cam shoulders 32 for providing for the operative positioning and removal of the filter element 20 from within the pressure-vessel 30. The pressure vessel 30 also contains an inlet port 46 for receiving liquid, such as, for example, water from an exterior source under line pressure, using, for example, a connecting structure 36, as shown in FIG. 1. The shroud 42 shown in FIG. 3 acts as a baffle to protect the filter media as the liquid flow enters the pressure vessel 30 through the inlet port 46 operatively positioned in the side of the pressure vessel. The presence of the shroud 46 changes direction of the flow of liquid through the inlet port 46. An opening 52 of the shroud 42 is in fluid communication with the filter media 44. A hollow interior 47 of the filter media 44 receives filtered liquid, such as water.

The liquid filtration system is designed in such a manner that damage to the filter media is substantially prevented when the filter media is operatively positioned in a filter element operatively positioned within the liquid filtration system in that the fluid flow as the flow enters the pressure vessel through the inlet is substantially prevented from impinging directly onto the filter media. If the shroud was not positioned there to act as the baffle, the flow directly in pending the filter media would most likely cause erosion and damage to the filter media.

Among the many features of the present disclosure, one is the internal fluid processing flow path from the pressure vessel 30 into the opening 52 and to the filter element outlet 50. As best illustrated in FIGS. 2-5, the fluid from the external source under pressure enters the pressure vessel 30 at the pressure vessel inlet port 46 where upon the fluid impinges upon the shroud 42 and is forced to flow toward the opening 52 of the shroud 42 operatively positioned at the end 52 opposite from the end cap 40. At this point, the fluid contacts the filter media 44, i.e., carbon block, passes through the filter media contained therein, and enters the hollow portion 47 thereof, the hollow portion 47 being in fluid communication with hollow portion 55 of the handle 38 thereby enabling the now filtered liquid to be transported via an outlet 50 operatively positioned in the handle 38 to an end location, such as, for example, a container, a pitcher, a sports bottle.

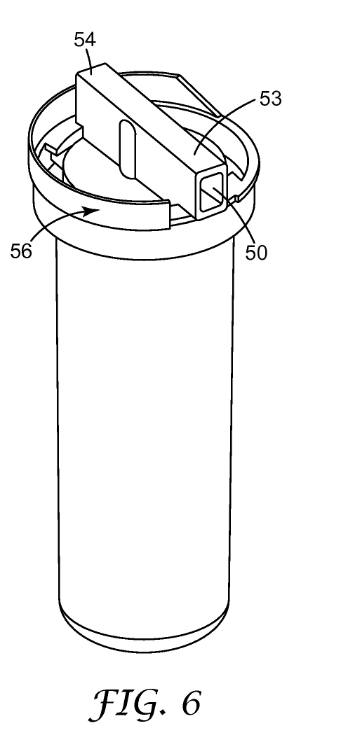

As clearly illustrated in FIGS. 3, 5 and 6, the end cap 40, which also serves as the pressure boundary surface in place of a traditional pressure vessel cover (head), contains a hollow portion thereof in fluid communication with the hollow portion 47 of the carbon block 44. When the pressure vessel 30 and the filter element 20 are combined, as shown in FIG. 6, they form an embodiment of the filter system of the present disclosure.

As shown in FIG. 6, a first end 53 of the handle 38 is slightly longer than a second end 54 and houses the hollow portion 55 that is in fluid communication with the hollow portion 47 of the carbon block 44. The second end 54 of the handle 38 operatively interacts with rotational limiting structure 56, as illustrated, operatively positioned on the pressure vessel 30, to ensure that the filter element 20 is properly positioned within the pressure vessel 30 such that the longer first end 53 of the handle 38 must be so positioned in order for the engagement ledge 60 of the filter element 20 and the pressure vessel 30 or other structure operatively connected thereto in order to secure filter element 20 properly within the pressure vessel 30, as would be known to those skilled in the art. This orientation feature also ensures that the fluid flowing from the end cap is always properly directed into the container since the filter element can not be installed improperly (e.g., 180 degrees out of rotation).

One additional design feature of the liquid filtration system of the present disclosure is the incorporation of a relatively simple means for conveying liquid from an external source to the container portion of the liquid filtration system. This design feature significantly minimizes the number of steps and/or reduces the amount of force (or torque) required to install and remove the liquid filter element from its location within the liquid filtration system compared to other point-of-use (POU) filtration systems.

In one representative example, the system of the present disclosure requires the operator to perform just one step to install or remove the filter element from the pressure vessel, i.e., twisting the filter element so it rotates to fit into the pressure vessel and to rotate in the opposite direction to remove the filter element from the pressure vessel.

Among the many embodiments of the present disclosure, is an embodiment having a structure for positively ensuring that the filter element is properly seated in the pressure vessel 30. As illustrated in FIGS. 7 A-C, a door 26 includes channel 70 operatively positioned thereon for operatively interfacing with the handle of the end cap, once the end cap is properly positioned relative to the pressure vessel. As illustrated in FIG. 7 B, when the filter element 20 is properly positioned within the pressure vessel 30, the channel 70 operatively positioned on the door 26 interacts with the handle 38 of the end cap 40 such that the end cap handle 38 does not prevent the lid from properly closing.

As illustrated in FIG. 7 C, when the filter element is not properly positioned within the pressure vessel 30, the channel 70 operatively positioned on the door 26 operatively interacts with the end cap handle 38 such that the end cap handle 38 prevents the door from properly closing (i.e., creates an interference), thereby giving an end user an indication that the filter element is not properly secured in the pressure vessel.

While specific structure has been used to illustrate the filter unit handle positioning function, it should be a understood that there are numerous other potentially as effective structures and/or techniques that would be equally effective and the inventors of the present disclosure and tend to include all such structures that would be operative to perform this function and any other structures or means that might be discovered in the future.

In addition, in one or more embodiments, installation and removal of the filter element from the pressure vessel is preferably done by means of a rotation action with only a single seal being required in the filter element. When the filter element is first placed into the pressure vessel, the filter element seal is not fully engaged and compressed within the pressure vessel so it will not effectively seal. Therefore if an end-user were to turn on the pressure supply to the pressure vessel there would be a noticeable leak but the filter element would not be dislodged as to cause potential injury to the user. As the filter is rotated the locking tabs on the filter element and pressure vessel engage, and due to the cam shape, the filter element gets pulled axially into the pressure vessel. The axial movement of the filter element into the pressure vessel causes the seal to engage and compress within the pressure vessel, thus preventing fluid leakage.

As also described above, one possible representative example includes, but is not limited to, a condition where the cover needs to be in the fully closed position in order to actuate the opening of a normally closed shut-off valve operatively positioned at a location between the fluid source and prior to the pressure vessel in the filtration system.

Reference throughout this specification to “one embodiment,” “certain embodiments,” “one or more embodiments” or “an embodiment” means that a particular feature, structure, material, or characteristic described in connection with the embodiment is included in at least one embodiment of the invention. Thus, the appearances of the phrases such as “in one or more embodiments,” “in certain embodiments,” “in one embodiment” or “in an embodiment” in various places throughout this specification are not necessarily referring to the same embodiment of the invention. Furthermore, the particular features, structures, materials, or characteristics may be combined in any suitable manner in one or more embodiments.

Although the invention herein has been described with reference to particular embodiments, it is to be understood that these embodiments are merely illustrative of the principles and applications of the present invention. It will be apparent to those skilled in the art that various modifications and variations can be made to the method and apparatus of the present invention without departing from the spirit and scope of the invention. Thus, it is intended that the present invention include modifications and variations that are within the scope of the appended claims and their equivalents.

What is claimed is:

1. A filter element comprising:
a carbon block comprising a first surface and a second surface;
an end cap to which the carbon block is secured, the end cap comprising a handle, wherein the handle defines a passage that is in fluid communication with the second surface of the carbon block and operatively connects the second surface with an end location; and
a shroud surrounding the carbon block, the shroud comprising an opening and being operatively connected to the end cap, wherein at least a portion of the first surface of the carbon block is in fluid communication with the opening of the shroud.

2. The filter element of claim 1, wherein the carbon block comprises activated carbon and a binder.

3. The filter element of claim 1, wherein the shroud is integral to the end cap.

4. A fluid filtration system comprising a filter element and a pressure vessel,
the filter element comprising:
a carbon block comprising a first surface and a second surface;
an end cap to which the carbon block is secured, the end cap comprising a handle, wherein the handle defines a passage that is in fluid communication with the second surface of the carbon block and operatively connects the second surface with an end location; and
a shroud surrounding the carbon block, the shroud comprising an opening and being operatively connected to the end cap, wherein at least a portion of the first surface of the carbon block is in fluid communication with the opening of the shroud; and
the pressure vessel comprising:
an inlet port that is adjacent to the shroud such that upon fluid flowing through the inlet port, the fluid contacts the shroud and the direction of flow changes, and wherein the inlet port is in fluid communication with the first surface of the carbon block.

5. The fluid filtration system of claim 4, wherein the end cap further comprises an engagement ledge and the pressure vessel further comprises an engaging cam shoulder, the engagement ledge and the engaging cam shoulder forming an interlock that connects the filter element to the pressure vessel.

6. The fluid filtration system of claim 4 wherein the pressure vessel comprises a limiting structure configured to ensure that the filter element is properly oriented relative to the pressure vessel.

7. The fluid filtration system of claim 5 wherein the pressure vessel comprises a limiting structure configured to ensure that the filter element is properly connected to the pressure vessel.

8. The fluid filtration system of claim 4 comprising means for ensuring proper connection of the filter element and pressure vessel.

9. The fluid filtration system of claim 5 comprising means for ensuring proper connection of the filter element and pressure vessel.

10. A fluid filtration system comprising:
a reservoir;
a pressure vessel affixed within the reservoir;
a filter element that is operatively connected to the pressure vessel; and
a lid affixed to the reservoir, the lid comprising a door having a normal operating position that is substantially flush with the lid;
wherein when the filter element is improperly installed, an interference between the filter element and the door prevents the door from obtaining the normal operating position.

11. The fluid filtration system of claim 10, wherein the filter element comprises a handle and the door comprises a channel configured such that when the door is in the normal operating position, at least a portion of the handle is located within the channel, and when the filter element is improperly installed, an interference between the filter element and the channel prevents the door from obtaining the normal operating position.

12. The fluid filtration system of claim 10, wherein the filter element comprises:
a carbon block comprising a first surface and a second surface;
an end cap to which the carbon block is secured, the end cap comprising a handle, wherein the handle defines a passage that is in fluid communication with the second surface of the carbon block and the passage operatively connects the second surface with an end location; and
a shroud surrounding the carbon block, the shroud comprising an opening and being operatively connected to the end cap, wherein at least a portion of the first surface of the carbon block is in fluid communication with the opening of the shroud.

13. The filtration system of claim 12, wherein the carbon block comprises activated carbon and a binder.

14. The filtration system of claim 13, wherein the binder is a polymer.

15. The filtration system of claim 14, wherein the polymer is ultra high molecular weight polyethylene.

16. The filtration system of claim 10, wherein the pressure vessel comprises an inlet port that is adjacent to the shroud such that upon fluid flowing through the inlet port, the fluid contacts the shroud and the direction of flow changes, and wherein the inlet port is in fluid communication with the first surface of the carbon block.

17. The filtration system of claim 11, wherein the pressure vessel comprises an inlet port that is adjacent to the shroud such that upon fluid flowing through the inlet port, the fluid contacts the shroud and the direction of flow changes, and wherein the inlet port is in fluid communication with the first surface of the carbon block; and wherein the carbon block comprises activated carbon and ultra high molecular weight polyethylene.
